(19) United States
(12) Patent Application Publication
(10) Pub. No.: US 2024/0403503 A1
(43) Pub. Date: Dec. 5, 2024

(54) METHOD AND APPARATUS FOR GENERATING INTERACTIVE ASSEMBLY INSTRUCTIONS

(71) Applicant: Yuval TSEMACH, Tel Aviv (IL)

(72) Inventor: Yuval TSEMACH, Tel Aviv (IL)

(21) Appl. No.: 18/800,065

(22) Filed: Aug. 11, 2024

Related U.S. Application Data
(63) Continuation of application No. PCT/IL2023/050221, filed on Mar. 5, 2023.
(60) Provisional application No. 63/317,553, filed on Mar. 8, 2022.

(51) Int. Cl. G06F 30/12; G06F 30/17

(52) U.S. Cl. CPC G06F 30/12; G06F 30/17

(57) ABSTRACT

A method, apparatus and computer program product, the method comprising: obtaining a unit description of a unit, and an associated assembly flow, the description comprising information about the unit parts; analyzing the unit description to obtain data for parts of the unit, comprising: determining part measurements; based on the measurements, determining a part type for each part; based on the types, generating a map of the unit; and generating a script for producing instructions for assembling the unit, comprising: repeating for each assembly event on the flow: extracting script commands for the event comprising: repeating for each relevant part or combination associated with the event, the relevant part retrieved from the map: adapting the script commands in accordance with the assembly event and accumulating the script commands as adapted to existing script commands generated on previous iterations of the assembly event and previous assembly events; and storing the script commands.

### CROSS REFERENCE TO RELATED APPLICATIONS

This application is a Continuation of PCT Patent Application No. PCT/IL2023/050221 having International filing date of Mar. 5, 2023, which claims the benefit of priority of U.S. Provisional Patent Application No. 63/317,553, filed Mar. 8, 2022, the contents of which are all incorporated herein by reference in their entirety.

### TECHNICAL FIELD

The present disclosure relates to a system and method for automatic or semi-automatic generation of instructions for assembling products.

### BACKGROUND

In recent decades and particularly in recent years, many products, such as but not limited to furniture, are provided as do-it-yourself (DIY) or ready-to-assemble (RTA) kits for self-assembly. Selling the kits rather than assembled units has many advantages. The price is significantly lower, as the seller does not have to store and ship the assembled unit, neither does the seller need to assemble the unit, neither at the seller premises nor at the buyer's home. The seller may thus store larger quantities of the unit, therefore shortening supply time. Moreover, the buyer can also assemble the unit immediately without waiting for a professional, and with the added value of self-esteem.

The kits include all parts of the unit to be assembled, including part such as boards and furniture fittings such as handles, and connecting members such as screws. If specific tools are required, they may be provided with the kit, as well.

The kits usually include assembly instructions provided as a hard copy, which is by nature two dimensional (2D). Additionally or alternatively, a Universal Resource Allocator (URL) is sometimes provided, which usually displays the same instructions. However, the instructions are very often confusing and not clear enough, and offer no flexibility to the person assembling the unit. It may be hard to tell the exact parts that are to be connected and how, how the parts are to be positioned relatively to each other, or the like, and no further information may be obtained.

On the other hand, generating the instructions for each such unit is burdensome and labor intensive, and incurs high costs on the manufacturer. Moreover, if there is a change in the instructions they need to be reprinted in case of hard copy, a scene needs to be reshoot and edited in case of video instructions, or the like.

Moreover, if the unit is shipped in multiple countries, the manufacturer must either attach the instructions in all available languages, including taking care of unit conversions such as metric vs. imperial systems, or make sure that the instructions attached to each unit are correct language or according to the country the unit is shipped to.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a flowchart of a method for generating instructions for assembling a unit, in accordance with some exemplary embodiments of the disclosure;

FIG. 2 is a 3D presentation of a door chest, in accordance with some exemplary embodiments of the disclosed subject matter;

FIG. 3A demonstrates bounding boxes and the relative locations therebetween, in accordance with some exemplary embodiments of the disclosure;

FIG. 3B demonstrates differentiation between parts using cross sections, in accordance with some exemplary embodiments of the disclosure;

FIG. 3C demonstrates differentiation between screw types using cross sections of the screw head, in accordance with some exemplary embodiments of the disclosure;

FIG. 4 shows a static image of screwing screw for connecting a hinge wing to a board, in accordance with some embodiments of the disclosure;

FIG. 5 shows a screwdriver with a screw for attaching a hinge to a door, in accordance with some exemplary embodiments of the disclosed subject matter;

FIG. 6 is a showing some exemplary parameters for animating screwing a screw into a board through a hinge wing, in accordance with some exemplary embodiments of the disclosed subject matter; and

FIG. 7 is a block diagram of a system for automatic or semi-automatic generation of animation script for assembling a unit, in accordance with some embodiments of the disclosure

### DETAILED DESCRIPTION

One technical problem of the disclosure relates to the difficulties of preparing and using assembly instructions for products or systems, such as but not limited to DIY or RTA products for example furniture.

Currently, most units to be assembled are provided with a hard copy of the assembly instructions, or a digital version thereof, which simply show the same instructions on a computerized display, without any added value beyond increasing the size of the displayed instructions. These instructions are often hard to understand and implement.

Another technical problem relates to the labor and cost of preparing printed instructions, producing a video guide, generating computer animation, or other media showing the assembly process. When preparing an assembly scene, whether it is printed or animated, each parameter of the illustration for the model needs to be created, distances and other relations between the parts need to be determined, time line, key frames and sequences need to be edited, as well as setting up viewing angles, zoom and other viewing parameters. All these tasks are created out with standard devices such as mouse and keyboard with no automation for the assembly instruction creation task, nor any insight related to the structure of the unit, for example that screws are driven into a door for attaching a hinge, which tool is used for screwing and how the tool should behave, selecting the correct screws at each stage, the best angle to look at a screwing event or the like.

Moreover, when the instructions are ready in any desired format, but changes need to be introduced, this may require again significant labor, time and price. For example, assembling a door hinge in a more efficient manner, in particular when the unit comprises multiple hinges, required manual editing in a plurality of locations and re-printing the printed manual, re-shooting and editing video clips, or the like.

The term script as used in the current disclosure is to be widely construed to cover a sequence of instructions that automate execution of tasks, or a sequence of one or more events in a software platform that create illustrations of models. Scripting languages may be interpreted at runtime rather than compiled. Scripts may also refer to macros or the like.

The term “assembly event” as used in the current disclosure is to be widely construed to cover an assembly stage, optionally comprising a sequence of assembly steps. An assembly event may be defined in accordance with its purpose, such as “assemble a drawer”. The term “assembly event”, “stage”, “assembly stage” or the like are used interchangeably in the disclosure below.

One technical solution is a system and method for automatically or semi-automatically generating a script for generating presentation of assembly instructions for a unit to be assembled. The method and system may receive a description of the unit, such as a Computer Aided Design (CAD) file, and generate upon the description a script presenting the assembly process. The script may then be used for displaying animated instructions to the person assembling the unit, producing a static computerized version of the instructions, printing a hard copy of the instructions, or the like.

A script provides multiple additional options for the instruction creator and for the person assembling the unit. Any medium of the instructions, such as animation, digital static, or hard copy, may be generated with or without accompanying text, vocal instructions, links for additional information or performing actions such as purchasing parts, or the like. The instructions, whether as animation or as a static illustration may be presented on screen or via vision, such as screens, glasses or headset devices that use Augmented Reality (AR) or Virtual Reality (VR).

The instructions can be displayed in any required language or using any unit system such as metric, imperial or others, such that the language and unit system can be selected in accordance with the preferences of the assembling individual. Selecting the language and system may also be performed automatically, using for example a Global Positioning System (GPS) data of the current location of the unit, and using the default language or system at that location.

Generating the instructions may comprise analyzing the product description, such as a CAD file describing of the unit, a Computer Numerical Control (CNC) file, any table or data set, created automatically by a computer or provided manually by human user. In some embodiments, additional data may be obtained, such as template script commands associated with each assembly stage or assembly event, upon which the script may be generated.

Generating the script may include analyzing the various parts and members of the unit, their dimensions, absolute or relative locations, followed by deducing their types. In the exemplary case of a piece of furniture to be assembled, the part types may include boards, screws, dowels, hinges, handles, or the like.

Each part may be associated with an initial location or position where it needs to be located during assembly, wherein the initial location may be relative to a location also referred to as reference, and wherein the initial location may differ from the final location. It would also be appreciated that different parts, different part combinations or different stages may be associated with different reference locations. For example, when assembling a drawer, the reference location may be a point on a bottom board of the drawer, while when assembling a box, the reference location may be any of the box's corners. The initial location may thus be relative to the reference location, for example an initial location of a screw may be such that its pointed end is at a predetermined distance, for example 1-3 cm above the point in the board it is screwed into.

An initial position may be defined as a linear offset in one or more directions from an original location in the unit description, or from a reference entity such as a different part. For example, for a screw inserted into a front door board from the back of the unit to the front, an initial location of the screw may be offset backwards along the shortest dimension of the board, in order to expose the screw prior to screwing. In this case, if the board is located such that its x dimension is the shortest, the initial position of the screw may be defined in (x,y,z) format as (−2,0,0).

An initial position may be more complex that just a linear offset in one direction. If for example, a stage in assembling a chest includes presenting left and right boards beside each other, where the internal face of each board faces the inner side of the chest, and the boards are aligned, an initial position for the two may require several linear offsets and rotations of one or more boards around one or more rotation axes. Similarly, when presenting animation, for example screwing a screw, the tool maneuver may be a combination of one or more linear movements, or one or more rotational movements and one or more additional movements.

The process may continue by identifying modules of the unit, comprised of multiple parts. Some exemplary modules related to furniture assembly may be drawers, doors, or the like. For example, a door may include a board, one or more hinge wings, one or more screw attaching each hinge wing to the board, and optionally handle and screws for attaching the handle to the door.

The script may then be generated in accordance with a predetermined order of stages or assembly events, associated with the particular type of unit or sub unit, wherein for each such stage a sequence of one or more script commands is generated, for example by retrieving template script commands associated with the stage and adapting them to the particular parameters of the involved parts or modules. The script commands may then be accumulated in their correct order into a complete script for assembling the unit.

Thus, in an example, a script for assembling a cupboard may include script commands comprising assembling each door, including hinges and handles on a predetermined order, assembling the body of the cupboard including assembling the side, top and bottom boards, followed by the back board, connecting the doors to the unit, and assembling door handles to the doors. When generating a script for assembling a drawer chest, the script commands may include script instructions for assembling the drawers in a predetermined order. When assembling a unit with drawers and doors, the doors assembly can be defined to occur following the drawers assembly.

Each such script command or script command sequence may be used for generating a visual presentation of the assembly stage. For example, a script for screwing a specific screw may show a screw driver and a screw being swiveled and advancing from their corresponding initial positions towards the board and then thereinto.

Analyzing the parts, identifying the modules, working through the assembly stages, and retrieving and adapting the script commands of each stage may be implemented as instructions in one or more computer programs. The computer program may be general, for example intended for multiple types of units such as all types of units, including storage furniture and engines, only storage furniture, a particular family of storage furniture such as all types and sizes of drawer chests, or specific to a particular unit, such as a drawer chest of particular size and having a particular number of drawers.

The process of unit analysis may be performed automatically, for example when it is required to generate a script for a new unit of a particular type, wherein all the unit parts are of known types, and template script commands are available for all stages of the assembly flow. For example, it may be required to generate instructions for a new furniture storage chest, of an unknown size and with an unknown number of drawers or doors. However, the drawers and doors are identifiable from the description of the unit, and template script commands are available for assembling drawers first if the unit includes drawers, and then doors if the unit includes doors, wherein the assembly stages for each drawer or door and the stage of assembling the drawers and doors in the complete unit are known, thus a complete script may be generated automatically without prior knowledge of the number of drawers and doors and their sizes. However, the disclosure may also relate to assembling a part of a unit, a specific stage in assembling, or the like.

The complete script may then be provided to a software or the like for executing the script, in order to present animation or static presentation, to generate a printed version, or the like. For example, the complete script may be animated by Solidworks Composer, Blender, Maya, Unreal, Unity, CryEngine, 3ds Max, GameMaker, Godot, Amazon Lumberyard, G2 Deals, CryEngine, ARKit or the like.

The full script or parts of an assembly event thereof may be associated with a default viewing parameters or behavior of the assembly stage or event, such as a viewing angle, a zoom ratio, zooming in or out, or other parameters that the script designer assumes are best for viewing. However, depending on the script display software or application, a person assembling a unit, may change the view angle, rotate the unit, zoom in or out, or the like. Additionally or alternatively, the full script or parts of an assembly event thereof may be associated with default animation parameters, such as distances and relative relations between parts of the animation, animation movement parameters order of animation of parts display, animation of tools required for the assembly, animation for comparing similar parts, onscreen presentation of number of similar elements used in assembly stages such as a few screws, and additional supportive information such as text, graphics, 2D or 3D animation, audio, video, or the like. In some embodiments, a code such as a QR code may be added. When a user scans the code, additional information may be displayed. It will be appreciated that the parameters and/or additional information may be automatically attached to a stage or event. The parameters and/or additional information may be pre-defined, or calculated based on unit or parts dimensions, the used tools, or the like.

In some examples, generating the script may be performed semi-automatically. For example, if assembly flow is only partly available or unavailable for a particular unit type, a user, such as a person preparing the script may copy and adapt an existing flow for a similar type, thus adding a minimal amount of work. For example, if animation is available for assembling a drawer, a user may use the available script, and provide assembly script for the unit body. In another example, the user may add script commands or computer instructions for recognizing a particular type of part, such as a special screw, and indicate how it is to be identified and used. Additionally or alternatively, a user may add, delete or change certain script instructions. The user may further add auxiliary materials to the script, such as audio instructions, text, links, images, or the like.

Current tools, which may include tools for creating animations and/or paper guides, are insensitive to the roles and interrelationships between different parts, groups of parts, or sub-assemblies of the CAD files, while the current disclosure resolves these relationships and uses them for creating the animated instructions.

The disclosure is not limited to assembling a unit or a sub-unit but may also be useful for animating common tasks or practices used in one or more applications, such as connecting two boards, connecting water pipes, or the like.

A person assembling the unit may receive a URL, use a native program, or use any other tool for receiving the assembly instructions in one of the enabled static or dynamic manners. The user will always receive the latest update available to the instructions.

One technical effect of the disclosure relates to the automatic or semi-automatic generation of scripts for displaying instructions for assembling a unit. The generation process, and particularly when programs for assembling similar units or sub units are defined, is fast and efficient, and requires little or no involvement of a user. The script may be generated with any required language or unit systems. The system and method may save significant labor and other costs associated with creating instructions.

A system in accordance with the disclosure also enables to update or upgrade the instructions and or the way they are presented with minimal or no effort. Once the instructions are provided online, the unit is not associated with any hard or soft copy of the instructions, and once a new version of the instructions is available, any person assembling the unit, anywhere in the world, can assemble more efficiently.

Another technical effect of the disclosure relates to obtaining a script for assembling a unit, the script being useful to a person assembling the unit, by presenting assembly instructions for the unit in a highly flexible manner. For example, the instructions may be viewed as static instructions or animated instructions, presented from different angles in accordance with the assembler's preferences, in different zoom ratios, with more or less detailed instruction according to the user preference, with text in any available language or system, with audio instructions, supportive animation, images, or the like. In addition, any time the instructions are updated, the installer will have immediate access to the updated version.

Yet another technical effect of the disclosure relates to the generation of the instructions being based on analyzing the unit, its parts and the roles of different parts, sub-assemblies and part groups. For example, when the unit comprises a screw, the system will not only relate to its outline, but will also recognize that it is a screw, what the screw type is, and that a screwdriver is required for installation, or the like. In another example, a board may be recognized as such, and also whether it is a back board, a front board, or the like. The type recognition can apply to higher levels, by recognizing part groups having a certain role, part segmentation such as all screws in an assembly, and the role of sub assemblies like, in the simple example of furniture: a drawer comprising a group of parts, a group of drawers, shelves and their holders or that a shelf that has to be under a group of drawers. Yet another technical effect of the disclosure relates to the semi-automatic script generation, in which a user preparing the instructions can amend and enhance the automatically generated script, and thus correct or adapt it better to the needs.

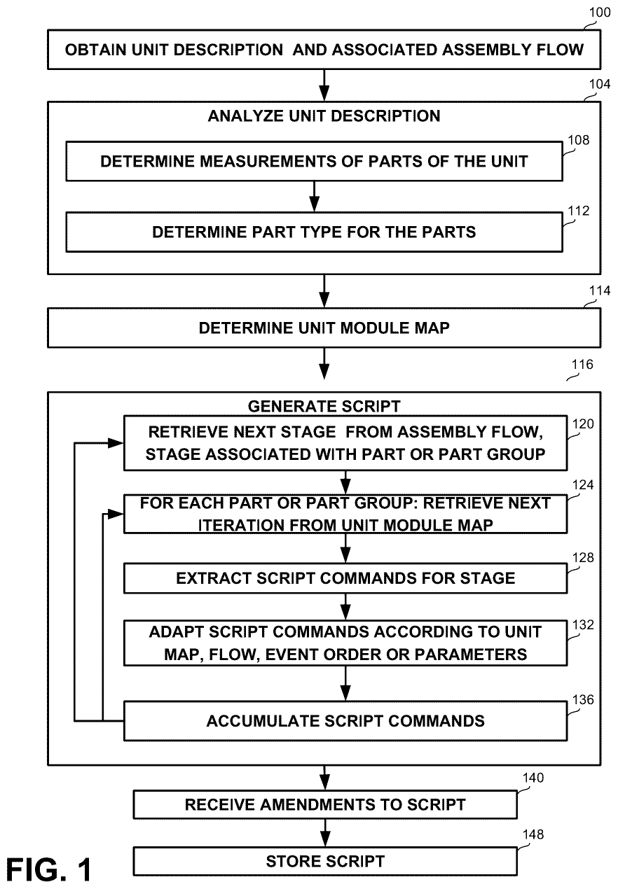

Referring now to FIG. 1, showing a flowchart of a method for generating instructions for assembling a unit, in accordance with some exemplary embodiments of the disclosure.

On step 100, a description of a unit may be obtained. The description may be in a computerized manner, such as a file, a stream, or the like. The description may be in the form of a Computer Aided Design (CAD) file, other 3D file for example of a format used in gaming applications, animation movies or other computerized simulation for presenting 3D images or the like. Information of the unit that may be utilized for unit analysis may be generated from a 3D file or 2D file. The information may be utilized to create unit description, such as a design table that accumulates data required for creating a 3D model, a table listing the parts or part groups, or in any other known or proprietary format. The description may include additional information that can be used in the unit description analysis detailed below, including elements such as measurements, CAD entities or information about/on reference geometries, planes, faces, cross sections, axes, points, lines, coordinates, sketch entities, holes, arrays and patterns, extrudes, cuts, extrudes, edges, faces, sheets, mates or constrains that define relative locations between CAD elements, and other information, elements or parameters used in 3D modeling or meta data on 3D elements. For example, a part or sub assembly can be named in a character string that identifies its role, a central axis of cylindrical element like screw, shaft or washer may already exist in CAD file, saving calculations in further stages, the front face of a board may already be defined, or the like. Other file formats such as CNC files may also be utilized. Each part of the unit may be identified and may be assigned a unique ID.

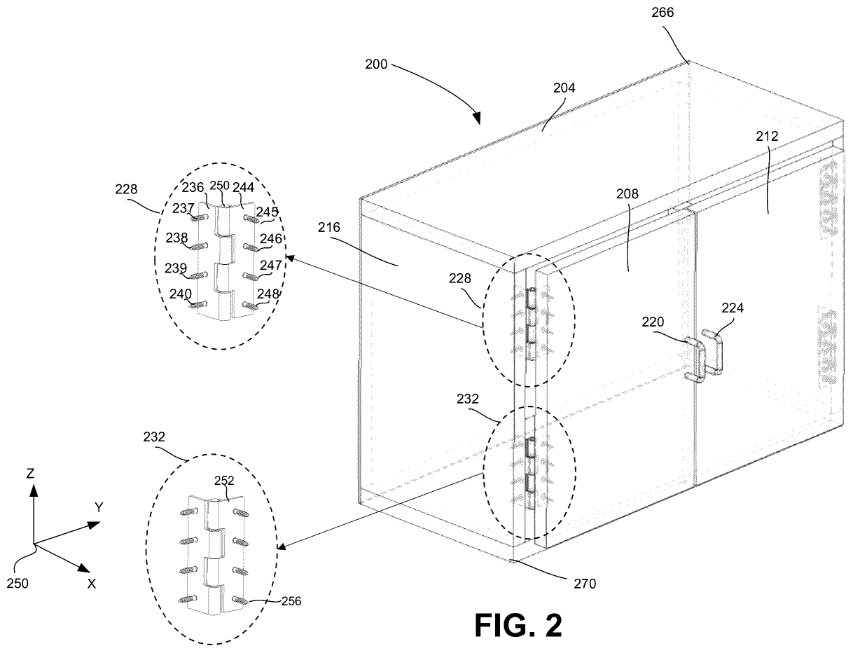

Referring now also to FIG. 2, showing a 3D presentation 200 of a door chest created with CAD software, including back cover 204, left door board 208 with handle 220, right door board 212 with door handle 224, and chest left side board 216. It will be appreciated that the unit also comprises a chest right side board and a bottom board (not shown).

Chest left side board 216 is connected to left door board 208 via a top hinge and screws generally referenced 228, and a bottom hinge and screws generally referenced 232. Top hinge and screws 228 comprise a first hinge wing 236 attached to chest left side board 216 using screws 237, 238, 239 and 240, a second hinge wing 244 attached to left door board 208 using screws 245, 246, 247 and 248, and a hinge pin 250. Bottom hinge and screws 232 have a corresponding structure, including left wing 252 and four screws, including screw 256. The right board is connected to right door 212 in a similar manner.

In some embodiments, a unit type may be obtained explicitly, whether as part of the description or separately. The unit type may be general and indicate for example, that it is a piece of furniture, an vehicle or part of a vehicle such as an engine, an elevator, an escalator, a crane, a bridge, a construction of a building, a loudspeaker, a water boiler, an air conditioner, a musical instrument, a toy or any other unit that has to be assembled. Additionally or alternatively, a more specific type may be provided, for example, a piece of furniture may be indicated as a drawer chest, a cupboard, a bed, a chair, or the like. However, the unit type may be omitted and deduced implicitly during the script generation. For example, if the unit comprises doors, then parts of the assembly flow related to doors may be executed and script command may be generated for them if the unit comprises one or more doors. If the unit does not comprise doors, these parts will not generate script commands. It will be appreciated that the unit type may be verified for compliance with the system, such that only verified CAD files can be used for generating animated instructions. Verification may be performed, for example, by searching for a particular identifier field, attribute or identifier within the file.

Additionally, relevant assembly flows, which are general or are associated with the type of unit to be assembled may be obtained. The assembly flow may be provided as computer program describing a list of stages, and a collection of script commands associated with the step, wherein each stage may be repeated multiple times. Each step may also be associated with a string title or another identifier, a pointer to where additional commands are to be found, or the like. For example, the assembly flow for assembling a drawer chest may consist of the following stages:
Assembling the drawers, one at a time from top to bottom and from left to right. Assembling certain types of drawers may comprise assembling in the right order the left and right boards, front and back boards, and then bottom, then attaching the left rail and the right rail to the left and right board of each drawer, respectfully.
Assembling the unit body, including left and right boards, top and bottom boards, and back panel;
Attaching the rails to the unit body; and
Placing the drawers within the unit body.

In the same manner, assembling a door chest may comprise the following steps:
Assembling the doors, one at a time from top to bottom and from left to right. Assembling each door comprising assembling the relevant wing of each hinge to the door board with the required number of screws.
Assembling the unit body, including left and right boards, top and bottom boards, and back panel, including assembling the wing of each hinge that connects to the unit body with the required number of screws;
Attaching the door with hinge wings to the unit body; and
Attaching the doors to the unit from top to bottom and from left to right, by inserting the connecting pin to connect the corresponding hinge wings of the door and the unit body.

It is seen that while assembling the unit body may be common to different types of furniture, they differ in later stages, in which hinges are assembled in case of a door chest and rails are assembled in case of a drawer chest.

In addition, the instructions may include sub-sequences arranged in one or more hierarchies, such as a screw, an array of screws, attaching two boards, attaching several drawer and door chests into a kitchen chest array, or the like.

Additionally or alternatively, the steps may be more general and applicable to any furniture, for example:
If the unit comprises doors, assembling the doors, one at a time from top to bottom and from left to right. Assembling each door comprises assembling the wing of each hinge to the door top to bottom board with screwing the required number of screws.
If the unit comprises drawers, assembling the drawers, one at a time from top to bottom and from left to right. Assembling each drawer comprising assembling the left and right boards, front and back boards, and then bottom board, and attaching the left rail and the right rail to the left and right boards of each drawer, respectfully.
Assembling the unit body, including left and right boards, top and bottom boards, and back panel; and
If the unit comprises doors, attaching the doors to the unit from top to bottom and from left to right, by inserting the connecting pin to connect the corresponding hinge wings of the door and the unit body.
If the unit comprises drawers, placing the drawers within the unit body.
If the unit comprises doors, drawers and shelves, the unit body will be assembled. All fixing that are attached to unit body will be assembled; hinge wings for doors, drawer side part of slide for drawers, and shelf holders for shelves. The assembly sequence can be as follows:
   Assembling all drawers and doors-
   Assembling all shelve boards located less than 2 centimeters below drawer
   Assembling drawers to the unit body-
   Assembling all shelf boards remained to the unit body-
   Assembling drawers to the unit body.
      In this assembly sequence for example, the user is guided to put the shelves to the unit body before the doors, because assembled doors may block or interrupt the assembly process of shelves. Moreover, it is better and easier to assemble all fixing that are attached to unit body, especially hinge and slide parts, before assembling the unit body. Assembling hinge wings and slide parts are much easier to assemble on a board that is placed on a table, rather than having to bend into a cabinet or climb a ladder for the higher elements. This proposed improvement may be implemented in a software update. The improvement suggested may be relevant for any furniture unit compromise doors or drawers. When having a collection of hundreds or thousands of furniture unit designs from one or more manufacturers, the advantage can be huge and implemented in minutes and save a lot of time money and effort. In addition, this logic of assembling hinge wings on main unit parts before assembling unit body itself, for example, may be relevant to applications other than furniture like doors of a vehicle like car, tractor, or a helicopter. The improvements may be hierarchical, for example a lower level may relate to a preferred method to drive a screw of door slide, or to a higher level such as a preferred order to place and assemble kitchen chest arrays; one beside the other or one on each other etc. The sequence may also change when if sub units are present not, for example, when having single chest unit, the handles of drawers or doors will be assembled after the drawers and doors are assembled to the chest body such that they can be aligned.

On step 104, the unit description as received may be analyzed to obtain information about the different parts

On step 108, measurements may be determined for parts of the unit using any analysis tool for determining measurements in three dimensions. For example, if the unit description is a CAD file, the measurements may be determined by activating a utility of a CAD software, accessed directly or via an Application Program Interface (API) for determining dimensions within unit description.

The measurements may include for each part a bounding box within which the part is contained. The bounding box may be a minimal bounding box, such that each dimension is of the minimal possible size. The bounding box may be represented as a minimal and maximal value in each dimension, as a minimal value and size in each dimension, or in any other manner.

The unit description may be associated with an axis system such as axis system 250 of FIG. 2. The sides of the bounding box of each part may or may not be parallel to the axes of the axis system. For example parts 208, 212, 244 and 246 may have the locations or bounding boxes as in Table 1 below, wherein (X1, Y1, Z1), (X2, Y2, Z2) are the endpoints of a diagonal of the bounding box in cm, and (X_d, Y_d, Z_d) are the dimensions along each axis. It will be appreciated that the bounding box faces may be parallel to the model description (CAD file) origin planes and not necessarily parallel to any of the unit description entities.

TABLE 1

| Part number | X1 | Y1 | Z1 | X2 | Y2 | Z2 | X_d | Y_d | Z_d |
|---|---|---|---|---|---|---|---|---|---|
| 208 | 48 | 10 | 70 | 50 | 60 | 100 | 2 | 50 | 30 |
| 212 | 48 | 10 | 39 | 50 | 60 | 69 | 2 | 50 | 30 |
| 244 | | | | | | | 1 | 5 | 4 |
| 246 | | | | | | | 1.5 | 0.5 | 0.5 |

It is seen that while bounding box dimensions X_d, Y_d, Z_d of door board 208 and door board 212 are identical, their locations within the axis system differ in the Z dimension.

The relations between the bounding boxes of different parts may indicate their relative locations and positions, for example parallel or at an angle.

In case of a non-parallel bounding box face relation, the relative position and angle may be obtained by measuring several distances between points over the bounding box face.

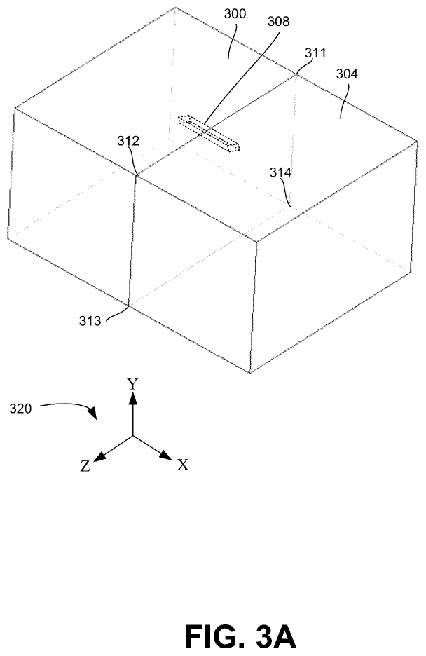

Referring now to FIG. 3A, demonstrating bounding boxes and the relative locations therebetween, in accordance with some exemplary embodiments of the disclosure. FIG. 3A shows a first bounding box 300 and a second bounding box 304 (referred to hereinafter as “boxes”). The face defined by vertices 311, 312, 313 and 314 is common to box 300 and box 304, therefore the parts contained within these boxes may be adjacent to each and touch over the face. In other situations faces may touch at a point, along a line, partially overlap, or the like.

FIG. 3A also shows axis system 320, and demonstrates the relation between parts and the axis system. In this example, since box 304 has higher values in the X dimension than box 300, it is deduced that box 300 is on the rear and box 304 is in the front of the unit.

FIG. 3A also shows bounding box 308, which partially overlaps box 300 and partially overlaps box 304. This overlapping can be mathematically deduced by the overlapping (or full or partial containment) between the bounding boxes as represented by their locations and sizes. Thus, the element contained within box 308 may be a connecting part, such as a dowel connecting box 300 and box 304. It will be appreciated that in the same manner a relation can be derived from bounding boxes that are distant from each other, such as two hinges in an array on a door which are positioned one above the other, angled, fully or partly overlap, distant in multiple dimensions, or the like

On step 112, a part type may be determined for one or more parts of the unit, for example all parts of the unit. The part type may be determined based upon the absolute dimensions of the bounding boxes, and/or their relationships. For example, a part for which two dimensions are significantly larger than the third, for example at least 10 times larger, may be identified as a board. If the small dimension is less than 5 mm in size, it may be a back board, since it is a piece of furniture, in which the back board is usually a thin board.

Screws or dowels may be identified by two dimensions of the bounding box being identical and significantly smaller than the third, and a hinge wing may be identified according to its absolute dimensions. In another example, when generating instructions for assembling a motor, this relation of two identical dimensions of bounding box while the third is significantly larger may provide an indication that the shape may be a plug, a spring, a shaft or the like. The absolute dimensions may also be used for determining the part type.

Thus, Table 2 below shows the parts as in Table 1 above, with the additional type as identified automatically.

TABLE 2

| Part | | | | | | | | | | |
|---|---|---|---|---|---|---|---|---|---|---|
| number | X1 | Y1 | Z1 | X2 | Y2 | Z2 | X_d | Y_d | Z_d | Part type |
| 208 | 48 | 10 | 70 | 50 | 60 | 100 | 2 | 50 | 30 | board |
| 212 | 48 | 10 | 39 | 50 | 60 | 69 | 2 | 50 | 30 | board |
| 244 | | | | | | | 1 | 5 | 4 | Hinge wing |
| 246 | | | | | | | 1.5 | 0.5 | 0.5 | Screw/dowel |

It will be appreciated that part type may also be identified based on any one or more of the dimensions being of a predetermined value or within a predetermined range, for example if any dimension is between 0.3 cm and 2.3 cm, and the other two dimensions are larger than 3.5 cm then the part type may be a board; if any combination of the dimensions is 1 cm×5 cm×4 cm then the part type may be a hinge wing; if two dimension are smaller than 0.52 cm and the third is larger than 0.52 cm then the part type is a screw or a dowel.

Referring now to FIG. 3B, demonstrating the differentiation between a screw and a dowel using illustrated cross sections, in accordance with some exemplary embodiments of the disclosure.

FIG. 3B shows a screw 340 and a dowel 358 having substantially the same bounding box size. Thus, cross sections may be used for differentiation therebetween. For example, a cross section through cut 344 depicted in 348 shows a circle of a certain, while a cross section through cut 362 depicted in 356 shows a significantly smaller circle. FIG. 3B also shows dowel 358. Cross sections 368 and 372 through cuts 360 and 364, respectively, depict circles of the same size. Thus screw 340 and dowel 358 may be differentiated using cross sections. The size of a circle may refer to the circle area, circumference, radius, diameter or another calculation.

Further, analysis of a cross section going through the top of screw 340 may determine whether the screw is a slotted screw, a Phillips screw, an Allen screw, or the like.

Thus, the type of any part, group of parts or sub element of the unit may be determined using the dimensions, the measurements and/or relationship between them, and simplified image analysis along cross sections.

Referring now to FIG. 3C, showing illustrations of four cross sections of different screws, the cross sections taken through the screw head. Once it is known that the part type is a screw, simplified image analysis may be used for classifying the screw head type in accordance with the opening in the cross section can be determined, such as flat as in cross section 380, Philips as in cross section 382, or Allen as in cross section 384. Moreover, the required size of the Allen screw may be determined, for example by measuring the diameter of the bounding circle of the hexagon found within the cross section.

In some embodiments, the unit description may be provided as a table summarizing the information about the dimensions, location, or type may be, thereby saving the need to execute the calculations above.

In some embodiments, an initial presentation location may be determined for each part. For example, in order to demonstrate how a screw is to be screwed, it needs to be presented first at some initial distance from the board or another part it is being screwed into. The distance may be constant, for example 2 cm regardless of the screw size, the board size or the like, or may depend upon any of them, for example be presented such that its penetrating end is distanced from the board at 50% of the screw long dimension. For example, a screw of dimensions 0.5*0.5*2 will be initially presented such that its penetrating end is at 1 cm distance from the board, and then approaching it and penetrating the board.

In some embodiments, an advancement direction may also be determined for the part, and associated and stored with it. For example, a screw connecting a hinge wing to a door may go from the hinge wing towards the door, and more specifically towards the side of the door opposite the side to which the hinge is attached. Alternatively, the advancement direction of a screw may be along the line from the large cross section to the small cross section of the screw. Alternatively the advancement direction may be obtained from the side of the screw that is overlapping with another part, since it is known that the screw head may not overlap. Thus, the advancement direction is towards the overlapping side of the screw.

Once a part type is identified, a corresponding tool may be determined which is required for assembling the part, such as a Phillips screw driver for a Philips screw, Allen key for Allen screw and a like. The corresponding tool may be added as a part to the unit and assigned an identifier, or as an auxiliary tool. A corresponding initial location may be associated with the tool as well. The tool may later be displayed when the part it is associated with is handled.

Thus, further information may be collected for the parts above, as shown in Table 3 below:

TABLE 3

| Part number | Part Type | Initial position | Tool |
|---|---|---|---|
| 208 | Board | (0, 0, 0) | |
| 212 | Hinge Wing | (0, 0, 0) | |
| 244 | Screw | 3.5 cm away from board | Phillips screw |
| | | (referring to the tip)_{—} | Driver−> |
| 280 | Phillips | 1.5 cm away from screw- | |
| | screwdriver | head | |

In some embodiments, one or more parts may be replaced with equivalent one or more other parts, for example if they look clearer or may be separated into different parts that may be moved independently of each other, have better colors, have some deformations or divisions, additional or different additions, cavities or cuts such that the parts that look better, are easier to recognize, better clarify the instructions, or the like. For example, a hinge represented as a single part may be replaced by three distinct parts, being the hinge's two wings and the connecting pin. Additionally or alternatively, virtual elements may be added similar to the screw driver mentioned above. For example, an arrow indicating the direction of a part may be added to show the relative position or movement, dimensions or other values may be displayed, a text indicating the number of holes or an index of a screw hole in a row of holes may be added at a location corresponding to the hole, or the like. Additionally or alternatively, a modification may be performed to the part, for example change of color, texture, transparency, cuts, holes, signs on the part, text or sign engraved or emboss on the part, or other visual or mechanical attributes that will make the illustration clearer.

The screw center axis orientation may be determined as being perpendicular to the face of the bounding box having the smaller area, and going through the center point of the face. For example, for screw 246, the bounding box face with the smaller area that is parallel to the YZ plane, so the axis is perpendicular to the face and to the XZ plane, the center point is (y,z) and it may be calculated as (Y1+(Y_DIM/2), Z1+(Z_DIM/2)),

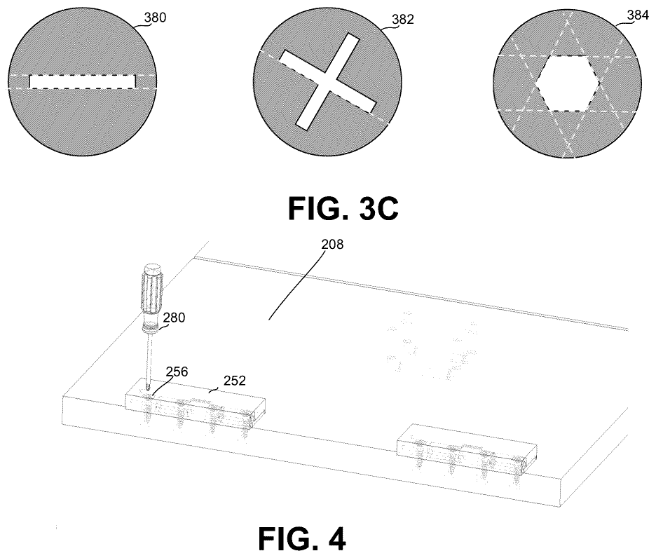

Rereferring now to FIG. 5, showing screwdriver 280 along screw center axis 500, such that screwdriver 280 will meet and enter into the screw, in accordance with some exemplary embodiments of the disclosed subject matter. The screwing orientation may be defined in degrees, radians, or another unit, and the screwing orientation direction may be defined using the common right-hand rule, indicating that when looking on a screw face (or a water tap handle) rotating clockwise will close the screw (or tap).

Additional exemplary parameters may include the number of rounds that will be animated, and may be set to a predetermined number, for example two, which may be sufficient for understanding the motion of orientation while moving forward but will not take too long to present. The actual number of rounds that need to be performed may be obtained by counting the number of angles created by thread slits along a cross section.

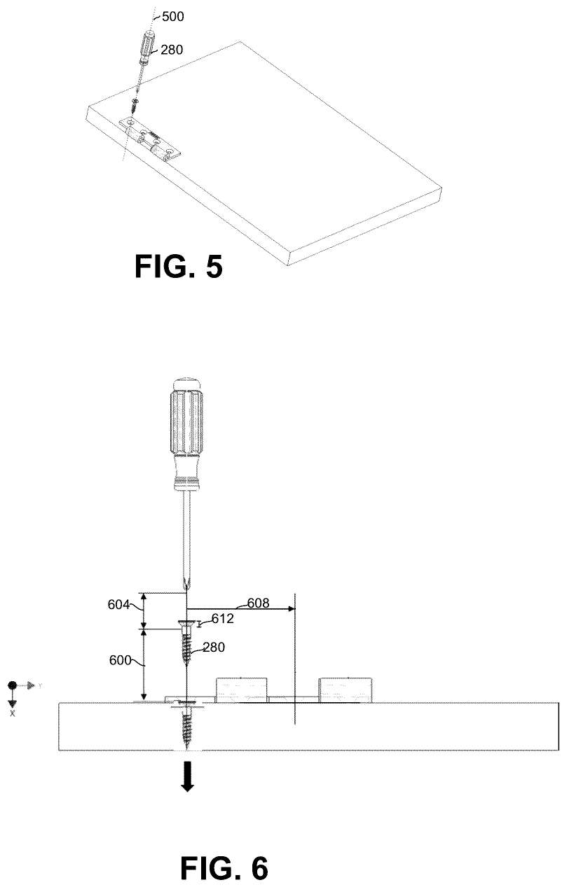

Referring now to FIG. 6, showing some exemplary parameters for animating screwing a screw into a board through a hinge wing into a board, in accordance with some exemplary embodiments of the disclosed subject matter.

Each part type may be associated with an initial presentation position, which may be relative to the initial presentation position of another part. For example, a screw may be presented in a certain distance from the board. Thus, screw 280 may be presented at distance 600 from the board.

The screwdriver may be presented at a larger distance from the board, such as distance 600 of the screw from the board 600+distance 604 of the screwdriver form the screw.

Yet another parameter is the distance the tool needs to go sideways from one screw to the other, referred to as the travel vector, shown as travel vector 608.

Yet another parameter of the screw is depth 612 of the deepest point within the screw into which the screwdriver goes, referred to as screw inter-phase border.

It will be appreciated that some motions are neither linear nor rotational, for example an arch-like motion, a motion combined of a linear component and a rotational component, or the like. Motion may be applied to a part or a part group. A motion may occur simultaneously, for example simultaneous linear movement and rotation. A motion may be relative to one or more references, an example to an initial point, plane, path, face axis or the like. A motion session may include one or more simultaneous or serial different motion sessions.

It will be appreciated that although the description above is exemplified mainly for boards and screws, it is equally applicable to other part types, such as a shaft, a peg, a wheel, a slide wheel, a cog wheel, a nut, a bolt, a washer, or the like.

On step 114, a map of the unit may be created, including linking related parts into modules and determining relations between parts and parts groups. For example, a board may be associated with one or more hinge wings, and with one or more screws attaching each hinge wing to the board, thereby creating a door. A hinge may include center rod 250, and may come as one unit including two wings and assembled as a single piece to a door board or to a chest side board.

A module, also referred to as a complex part, may be identified according to a part type and the relations between the bounding box of a part and the bounding boxes of other parts. For example, the bounding boxes, cross sections, or any other 3D file entity, may be adjacent along a face, adjacent along an edge, tangential, or have a predetermined value or a value within a predetermined range of distance between face, angle between faces, distance between points, distance between lines, angle between lines, line, area or volume overlap, or any other positional relations expressed for example as distance and angle, or a combination thereof. In other words the positional relations may be but are not limited to any of the following: adjacency along a face, adjacency along an edge, face tangency, surface tangency, curve tangency, arc tangency, path tangency, distance between faces, angle between faces, distance between planes, angle between planes, distance between points, distance between lines, angle between lines, angle between edges, distance between lines, line overlap, area overlap, angle overlap, path overlap, curve overlap or volume overlapping. For example, a door may be identified by detecting a board, optionally having a handle with a bounding box adjacent to that of the board, at least one hinge with a bounding box adjacent to that of the board, and for each hinge one or more screws having a bounding box which at least partially overlaps the bounding box of the board. Alternatively, identification may start by locating a leading member of type hinge, followed by identifying the board connected to the hinge and the relevant screws, thereby identifying a door.

Similarly, a drawer may be identified by four boards positioned as drawer walls in a rectangle shape, a bottom board, and two rails adjacent to two parallel side boards. Alternatively, a drawer recognition may start from a leading member being a rail or a pair of rails, and the boards to which the rails are attached, etc.

In some embodiments, all modules of the same type, such as doors, drawers, or the like, may be identified and arranged, for example in an array, such that they may be iterated by traversing the array. Some parts of the module, such as the hinge wings or screws, may also be arranged in a traversable manner, such as an array nested within the module array.

Step 114 for mapping the unit may comprise serial or nested operations. For example, a handle of a drawer may be related to a group of parts for door assembly, and may be assembled as part of the door. Alternatively, the handle may relate to the furniture unit in general, and may be assembled at the end of the unit assembly.

When determining modules, a number of assumptions may be made in order to maintain consistency. For example:
The front side of a unit may be in the direction where the X values are increasing. Alternatively, if the front, back or sides have been defined according to the axes, this information may be used.
Doors are located at the front of a unit, face the front, and share the same front plane (e.g., X2 value which is greater than X1 value).
Each door has at least one hinge located at the back of the door, i.e., on the lower X value.

Each door may be determined based for example on the boards for which the shortest bounding box dimension parallel to the x axis, i.e., they face front and back. Thus, parts 204, 208 and 212 may be detected as door board candidates. Out of these, part 204 has a lower X2 value and is therefore rejected. Parts 208 and 212 have the same and the highest X2 value, i.e., they are farthest from the origin along the x axis direction, which was defined to be directed to the front of the chest.

It may then be determined which of the boards constitute parts of doors, for example by having a part of type “hinge wing” having a bounding box adjacent to the bounding box of a board.

Thus, since each of boards 208 and 212 has two hinge wings adjacent to it, it is determined that the unit comprises two doors, having boards 208 and 212, and the relevant hinge wings may be associated with them, in a predetermined order, for example from left to right and from top to bottom.

In a similar manner, the two hinge wings of each door may be traversed, for example from top to bottom, or in any other order. For each one, the screws that have a bounding box overlapping with the hinge wing are associated with it. The screws associated with each hinge wing may be ordered from left to right and from top to bottom or in any other order

An exemplary template data structure of a door assembly may be as follows: a first section describes attaching hinge wings and screwing hinge screw of a door. This section may be applied to screwing hinges on any unit. The part type is followed by an index of the part. The parameters in parenthesis indicate the assembly parameters.

```
Door Board_1(Initial Position)
[
  Door Hinge Wing_1(Initial Position)
  {
      Screw_1 [ (Initial Position) , Screwing Direction , Screwing
      Orientation, Travel Vector , Number of Rounds] ,
      ...
      Screw_n [ ] ,
  }
    , ... ,
  Door Hinge Wing_n (Initial Position)
  { ... }
    , ... ,
]
```

Thus, a corresponding data structure may be created upon the template, for the actual doors of the unit, using the parameters as determined:

```
208 (0,0,0)
[
  244 (0,0,0)
  {
    245 [ (−3.5,0,0) , x_negative , x_negative , (0,0,0) , 2 ],
    246 [ (−3.5,0,0) , x_negative , x_negative , (0,+1.7,0) , 2 ],
    247 [ (−3.5,0,0) , x_negative , x_negative , (0,+1.7,0) , 2 ],
    248 [ (−3.5,0,0) , x_negative , x_negative , (0,+1.7,0) , 2 ],
  },
  252 (0,0,0)
  {
    245 [ (−3.5,0,0) , x_negative , x_negative , (0,0,0) , 2 ],
    246 [ (−3.5,0,0) , x_negative , x_negative , (0,+1.7,0) , 2 ],
    247 [ (−3.5,0,0) , x_negative , x_negative , (0,+1.7,0) , 2 ],
    248 [ (−3.5,0,0) , x_negative , x_negative , (0,+1.7,0) , 2 ],
  },
```

A similar data structure may be created for door board 212. It will be appreciated that analogous data structures may be created for other parts of the unit, such as the unit body, chest side boards, where the second hinge wing will be attached to. When generating instructions for chest side board rather than a door board, the, the relevant parameters may be automatically obtained in the same manner. Thus, with a minor adjustment the animation template may be reused Similarly, a hinge wing may be replaced by minimal adjustments with a part of a drawer slide

The collection of the data structures may be searchable, such that all parts or modules of a particular part type may be retrieved. For example, all doors within the unit may be retrieved, each with its own parameters.

Once the unit model map is available, further corresponding assembly tools may be determined. For example, if two parallel boards have to be tightened to each other, the distance from two far faces may determine the type and size of clamps to be used. The clamps may be located on constant distances from each other, on certain ratio of the board length, or the like. In another example, if it is determined that a part needs to be put face down, an auxiliary surface such as a table or a carpet may be displayed to prevent scratching the unit and the floor.

If several elements are recognized as similar looking and may cause confusion while assembling, for example, same size and different hole arrangement, the elements may be presented to the assembling person before assembly, with the differences explained, using animation, visual cues, text, audio, or the like.

On step 116 a script may be generated, which includes script instructions for displaying the relevant stages in assembling the unit.

The stages may be retrieved from an assembly flow relevant for the unit. The assembly flow may be implemented as a computer program which may comprise instructions for the relevant assembly stages, as a more general computer program which retrieves the stages from a configuration file, or the like.

In some embodiments the flow may be general, for example “If the unit contains doors, work through all doors from left to right and from top to bottom”. In other embodiments the flow may be specific to the unit, as in the following pseudo code:

“Assemble top left door;
assemble top right door;
assemble bottom left door;
assemble bottom right door”.

In further embodiments, the flow may be semi-specific: “work through all doors from left to right and from top to bottom”.

Thus, on step 120, a next stage may be retrieved from the assembly flow, the stage associated with one or more parts or part groups or part combinations.

On step 124, a next iteration may be retrieved for the stage retrieved on step 120, if applicable. For example, if the unit comprises two doors and three drawers, one stage may relate to the doors, and may be iterated twice, and a second stage may relate to the drawers and may be iterated three times.

The number of iterations may be stated in the flow as obtained on step 100, and/or from the part types or arrays thereof as retrieved from the product description on step 112, or the module map as determined on step 114.

Thus, iteration step 124 may be nested to traverse for each stage or part or part combination of the relevant parts or part combinations that are related to it, and further parts or part combinations that are related to them, such as the hinge wings of each door, and the screws of each hinge wing. Thus, nesting is not limited to two levels but rather any level of nesting can be applied.

On step 128, script commands relevant for the stage and the iteration, or an assembly event may be retrieved, for example from a text file, a database, a configuration file, a table, or the like. The script commands may relate to a certain stage, such as assembling a door, assembling a drawer, assembling a box or a frame, assembling a hinge, inserting a screw, or the like.

On step 132, the script commands may be adapted according to the unit module map, the flow, the event order or the parameters. The script commands may be adapted for the stage and the iteration, including setting parameters of the specific part arrangement or part group arrangement combination of the unit as described in the unit module map.

For example, a script for assembling a door board may be created, based for example upon the data structure as created based upon the template, as shown above.

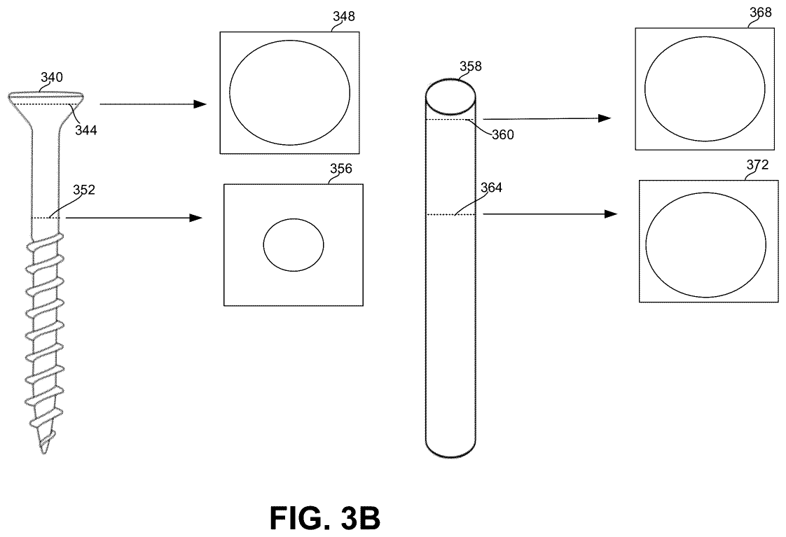

FIG. 4 shows a static image of screwing screw 256 for connecting hinge wing 252 to board 250, in accordance with some embodiments of the disclosure. It is appreciated that the static image may be representative of an animation of said screwing generated upon the template script commands.

In an example, a script may be generated which follows the assembly flow described by the pseudo-code commands listed in Listing 1 below. The relevant script commands may be retrieved for each such pseudo-code command, and adapted for each relevant part within the model. For example, pseudo-code command 4 below, which relates to a door, may be repeated for all doors in the unit, pseudo-code command 5 may be repeated for each hinge of each such door, and pseudo-code commands 6-12 may be repeated for each screw of each such hinge. The relevant parts are retrieved from the data structures detailed above.

The initial camera angle of command 2 may be defined as the diagonal between corner 266 of the unit and corner 270 of the unit, when looking from corner 266, because in this case the doors are covering more than 90% of front area the full model can be seen.

Listing 1

| | |
|---|---|
| 1. | Clear screen |
| 2. | Set initial camera angle. |
| 3. | Set scene frame to fit door in array |
| 4. | Show door on screen at its initial position |
| 5. | Show hinge wing of the door at its initial position |
| 6. | Show screw of hinge wing at its initial position |
| 7. | Show tool of screw at its initial position relative to the screw |
| 8. | Animate movement of screwdriver towards the screw head on |
| | screwing direction by reducing the distance between the |
| | screw head and the screwdriver tip to zero |
| 9. | Animate closing the gap between the screw tip and the board, |
| | where screwdriver and screw move together |
| 10. | Animate turning screwdriver and screw using screwing |
| | orientation, along screwing direction to for the |
| | predetermined number of rounds |
| 11. | Move screwdriver back |
| 12. | Animate screwdriver travelling the travel vector |
| | distance to the next screw |

It will be appreciated that Listing 1 above is general and additional commands or parameters may be added, such as parameters of the tool internal position, hiding the screwdriver when moving to a next door, colors, transparencies, timing of break, timing of animation, scene screen behavior, or the like. Further commands may also be added for creating script commands for assembling the unit itself, or additional parts thereof.

While Listing 1 comprises exemplary commands for assembling door hinge on a door board, additional commands may be provided for assembling the other parts or groups of parts of the unit, such as the door handles, the unit body, etc.

The code represented by the pseudo code may be used for generating scripts for assembling any unit with doors. Since the retrieval of elements of a certain type is automatic, the same code may be used for assembling a unit with any number of doors, and of any size or configuration. Moreover, code instructions may be added for generating script commands for assembling other parts or part group of the unit, such as drawers or shelves. Such code may thus be used for assembling any unit containing doors and/or drawers and/or shelves. If a certain unit does not contain any door, the code may still be used, wherein the door-related commands will not be executed since no part having a type of door will be retrieved.

The same code, or a different code may also be extended for assembling other types of furniture, units or sub units which are not furniture, such as engines, vehicle or part of a vehicle like, engine, elevator, escalator, crane, bridge, construction of a building, loudspeaker, water boiler, air conditioner, musical instrument, toy, or any other unit as long as relevant script commands are provided for any step represented by the code.

It will be appreciated that a code implementing the pseudo-code of Listing 1 may be written in any programming language, such as Python, Java, C#, C++, JavaScript or the like.

It will also be appreciated that the scrip commands retrieved in association with each command may be provided in any one or more scripting languages or script commands adapted to be executed by any web-based, native or local animation platform, such as Autodesk Fusion 360 º, Web-GL®, JavaScript, Unity®, Autodesk Maya®, Blender®, SOLIDWORKS Composer® or others to present web-based animation, native software installed on mobile computer or desktop computer, a presentation of a conventional video clip for example in AVI or mp4 format, or the like.

On step 136 the commands may be accumulated with script commands generated on previous stages and iterations, to continue creating the script for the unit. When script commands are ready for the full flow, all parts, or assembly events, they may represent the full assembly process for the unit.

On step 140, a user may introduce amendments to one or more commands of the script, may change or add script commands, for example commands that relate to viewing angles, zoom, viewing route, and combinations on each stage or sub step, on which index of an array to apply a behavior such as animation or viewing angle) blinking, auxiliary animation such as arrows, or the like. The user may also change the order of instructions, add instructions that the user thinks are required and have not been generated, or the like. Once the user has finished updating the script, the user may store the script as updated.

The user may further add additional aids to the script, such as audio cues or speech voice for guidance or explanation, add text with explanations, static or animated 3D or 2D illustrations, video, links to further data or purchasing items, or any other informative item. The user may further add notifications such as numbering each hole in a row of the holes such that the user can know which hole he is supposed to handle, displaying the distance between consecutive elements such as holes, boards, parts group of parts displaying the number of parts or part groups in an array or assembly stage, or the like.

On step 148 the script may be stored, for example in a storage device, and may be made available to staff members, consumers, or the like. Executing the script may show a static illustration or an animation of the assembly process, with benefits that may be associated with animation. For example, the user may change viewing angles, zoom in or out, measure sizes, select language, or the like. In further embodiments, one or more static images may also be displayed to a user.

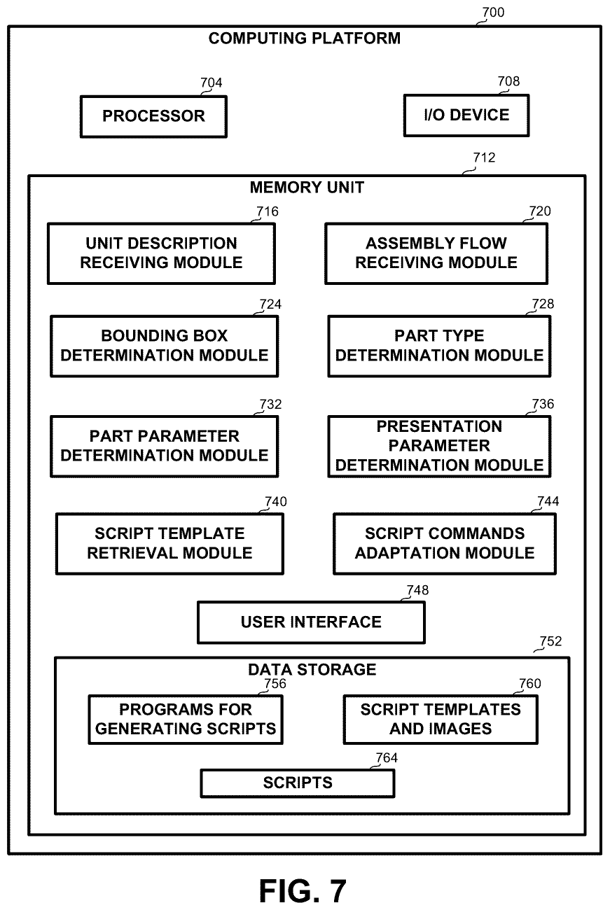

Referring now to FIG. 7, showing a block diagram of a system for automatic or semi-automatic generation of animation script for assembling a unit, in accordance with some embodiments of the disclosure.

The apparatus includes a computing platform 700 such as a desktop computer a laptop computer, a server, or the like.

In some exemplary embodiments, computing platform 700 may comprise a processor 704. Processor 704 may be a Central Processing Unit (CPU), a microprocessor, an electronic circuit, an Integrated Circuit (IC) or the like. Alternatively, processor 304 can be implemented as firmware programmed for or ported to a specific processor such as digital signal processor (DSP) or microcontrollers, or can be implemented as hardware or configurable hardware such as field programmable gate array (FPGA) or application specific integrated circuit (ASIC).

Computing platform 700 may further comprise I/O device 708 such as a display, a microphone, a keyboard, a touch sensor, a mouse, an audio device, or the like, for a user to interact with computing platform 700, such as providing commands, examining and enhancing the script, viewing execution results of the script or the like.

In some exemplary embodiments, computing platform 700 may comprise one or more storage devices such as storage device 712, for storing for example programs and data related to generating scripts, prepared scripts, or the like. Storage device 712 may comprise persistent and/or volatile storage devices. For example, storage device 712 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like.

Storage device 712 may store unit description receiving module 716 for receiving a description of a unit to be assembled, for example in a CAD format. Unit description receiving module 716 may also be useful for activating scripts for determining additional information from the description, such as distances, measurements, or the like. Unit description receiving module 716 may be implemented as part of or in connection with a CAD viewer application or program.

Storage device 712 may store assembly flow receiving module 720, for receiving an assembly flow that may contain the stages in assembling the unit. The assembly flow may be implemented as a computer program in any required language. The assembly flow may be general and suitable for multiple unit types, wherein some stages may or may not be applicable for some units. In some embodiments, the assembly flow may be specific for units of a specific type, for example drawer chests.

Storage device 712 may store bounding box determination module 724, for determining from the unit description the dimensions and location of the bounding box of each part of the unit. The bounding box may be determined using tools of the description viewer, data provided with the unit description, or the like.

Storage device 712 may store part type determination module 728, for determining a type for each part of the unit. The part type may be determined upon the absolute dimensions of the bounding box of the part, the relative dimensions, dimension ranges, or the like. In some embodiments, the part type may also be determined using image analysis techniques applied to cross sections of the description, using types or dimensions of other parts, or the like. The part type may be general, such as a screw, or more specific, such as a Philips screw.

Storage device 712 may store part parameter determination module 732, for determining parameters of each part, such as initial location at which it is presented, orientation, required tools which may be added as additional parts, or the like.

Storage device 712 may store presentation parameter determination module 736 for determining one or more parameters for presenting the animation, such as initial camera angle, zoom, or the like. The parameters may be set per the unit as a whole, per stage, per part type, or the like.

Storage device 712 may store script template retrieval module 740 for retrieving script commands relevant for one or more assembly flow commands, such that the script commands may be used for creating animation or another presentation of the assembly process.

Storage device 712 may store script commands adaptation module 744 for adapting the script commands to the particular parts of the unit and their parameters, such as size, location, orientation, or the like.

Storage device 712 may store user interface 748 for a user to provide input to the system or to receive output from the system via any of I/O devices 308. For example, user interface 748 may be used for viewing and editing the script commands, viewing the animation or another presentation of the assembly instructions, or the like.

Storage device 712 may comprise data storage 752.

Data storage 752 may store one or more programs 756 representing assembly flows for generating scripts. Each such program may relate to a specific unit or parts thereof, to a family of units such as units with doors, or to a plurality of unit types. Each such program may be written in any computer language such as Python, Java, C#, C++, or others, and when executed may use script templates and images 760 to generate a script 764.

Data storage 752 may store script templates and images 760, comprising for sequences of one or more script commands which generate a representation of the subject matter of one or more code commands. For example, a code command indicating rotating a screw driver and a screw, may be associated with one or more images of a screw driver or a screw, and one or more script commands showing their animated rotation.

Data storage 752 may store one or more scripts 764 which may have been generated by any of programs 756 using script templates and images 760. Each such script may be executed to present an animation, static instructions to be displayed over a display device or printed, vocal instructions, or the like. The added information, such as the vocal instructions or text may be retrieved dynamically, and thus presented in a language selected by a user.

The script may then be provided to an end-user assembling the unit. The end-user may then execute the script for generating animations, static instructions, or the like.

The script generation may be an interactive process, in which a user, such as a person in charge of preparing the instructions, may identify a module which is not automatically recognized, and may define such sub-assembly, including defining the parts contained therein, and providing or changing the relevant template instructions describing the assembly process of the sub-assembly. Them when generating scripts for future types of units, the newly-defined sub-assembly may be automatically recognized, and corresponding scripts may be generated as part of the script for assembling the units of the future types.

In a similar manner, the user may change the type of a recognized sub-assembly and may change its definition.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A computer-implemented method performed by a computerized device, comprising:
obtaining a at least a unit description of a unit to be assembled, and an associated assembly flow, the unit description comprising information about parts of the unit;
analyzing the unit description to obtain data for parts of the unit, comprising:
determining measurements of parts of the unit;
based at least on the measurements, determining a part type for each part of the unit;
based on the part types, generating a map of the unit; and
generating a script for producing instructions for assembling the unit, comprising:
repeating for each assembly event on the assembly flow:
extracting script commands for the assembly event comprising:
repeating for each relevant part or part combination associated with the assembly event, the relevant part retrieved from the map of the unit:
adapting the script commands in accordance with the assembly event and
accumulating the script commands as adapted to existing script commands generated on previous iterations of the assembly event and previous assembly events; and
storing the script commands as accumulated.

2. The method of claim 1, wherein determining the measurements comprises determining for each member a bounding box, and a distance between a reference location and a point of the bounding box, or distance between two points of the bounding box.

3. The method of claim 1, wherein the unit description is a Computer Aided Design (CAD) file and wherein the measurements are obtained from the CAD file by applying a feature of a CAD software that measures distances.

4. The method of claim 1, wherein obtaining the part type of a part or a part combination is performed in accordance with at least one of the following:
distance between points of the part or part combination, or between a point of the part and a reference location;
dimensions of a bounding box of the part or part combination;
dimensions or ranges of dimensions of a bounding box of the part or part combination;
comparing between proportions of the bounding box dimensions of at least two parts or part combinations;
comparing between proportions of the bounding box dimensions of the part or part combination and elements of a collection of predetermined proportion set, each element is associated with a part type; and
a combination of two or more of the above.

5. The method of claim 4,
wherein the part or part combination is selected from the group consisting of: a door, a drawer, a cabinet, a hinge, an engine, a lever, a slide, a construction, a platform, a skid, a pump, a valve, an actuator, a roller, and a lock, and
wherein the part type is selected from the group consisting of: a board, a cap, a screw, a dowel, a handle, a hinge, a cork, a pulley, a spring, a shaft, a rod, a shaft, a strap, a nut, a seal, a ring, a washer, a bolt, a flange, a pipe, a tank, a column, a propeller, a pulley, a wire, a cable, a connector, a socket, a plug, a slide, a wheel, hook, a knob, a sheet, a piston, a holder, a roller, a platform, a skid, and a tool.

6. The method of claim 1, wherein generating the map of the unit comprises identifying a part or part group, based on positional relations between bounding boxes of parts wherein the positional relations are calculated using distance between points and distance between faces of the bounding boxes.

7. The method of claim 1, wherein generating the map of the unit comprises identifying a part or part group, based on positional relations between a leading member, and members connected thereto, and wherein the positional relations comprise at least one item selected from the group consisting of: distance between points on the part or part group, and between lines associated with the part or part group.

8. The method of claim 1, further comprising receiving amendments to the script from a user.

9. The method of claim 1, wherein the script is enhanced with an addition comprising at least one item of the group consisting of: an audio segment, a video segment, 2D animation with audio, 2D animation without audio, 3D animation with audio, 3D animation without audio, a static 2D image, a static 3D image, a dynamic 3D image, a 3D illustration, a text, and a link.

10. The method of claim 1, further comprising providing the script commands to viewer, the viewer script adapted to present static illustration or dynamic animation of at least some of the script commands.

11. The method of claim 1, further comprising generating a visual representation upon the script commands.

12. The method of claim 11, wherein the assembly event is associated with a tool, and wherein the visual representation shows the tool or an operation of the tool to perform the assembly event.

13. The method of claim 11, wherein the assembly event or at least one part of the unit is associated with an auxiliary object or a virtual element, and wherein the visual representation shows the auxiliary object or the virtual element.

14. The method of claim 1, wherein at least one stage of the assembly event is associated with at least one of the following: a viewing angle, viewing travel, and zoom rate, to be used when visual demonstration is generated upon the script commands.

15. A computerized apparatus having a processor, the processor being configured to perform the steps of:
obtaining a at least a unit description of a unit to be assembled, and an associated assembly flow, the unit description comprising information about parts of the unit;
analyzing the unit description to obtain data for parts of the unit, comprising:
determining measurements of parts of the unit;
based at least on the measurements, determining a part type for each part of the unit;
based on the part types, generating a map of the unit; and
generating a script for producing instructions for assembling the unit, comprising:
repeating for each assembly event on the assembly flow:
extracting script commands for the assembly event comprising:
repeating for each relevant part or part combination associated with the assembly event, the relevant part retrieved from the map of the unit:
adapting the script commands in accordance with the assembly event and
accumulating the script commands as adapted to existing script commands generated on previous iterations of the assembly event and previous assembly events; and
storing the script commands as accumulated.

16. The apparatus of claim 15, wherein generating the map of the unit comprises identifying a part or part group, based on positional relations between bounding boxes of parts wherein the positional relations are calculated using distance between points and distance between faces of the bounding boxes.

17. The apparatus of claim 15, wherein generating the map of the unit comprises identifying a part or part group, based on positional relations between a leading member, and members connected thereto, wherein the positional relations comprise at least one item selected from the group consisting of: distance between points on the part or part group, and between lines associated with the part or part group.

18. The apparatus of claim 15, wherein determining the measurements comprises determining for each member a bounding box, and a distance between a reference location and a point of the bounding box, or distance between two points of the bounding box.

19. The method of claim 15, wherein obtaining the part type of a part or part combination is performed in accordance with at least one of the following:
distance between points of the part or part combination, or between a point of the part and a reference location;
dimensions of a bounding box of the part or part combination;
dimensions or ranges of dimensions of a bounding box of the part or part combination;
comparing between proportions of the bounding box dimensions of at least two parts or part combinations;
comparing between proportions of the bounding box dimensions of the part or part combination to elements of a collection of predetermined proportion set, each element is associated with a part type; and
a combination of two or more of the above.

20. A computer program product comprising a non-transitory computer readable storage medium retaining program instructions configured to cause a processor to perform actions, which program instructions implement:
obtaining a at least a unit description of a unit to be assembled, and an associated assembly flow, the unit description comprising information about parts of the unit;
analyzing the unit description to obtain data for parts of the unit, comprising:
determining measurements of parts of the unit;
based at least on the measurements, determining a part type for each part of the unit;
based on the part types, generating a map of the unit; and
generating a script for producing instructions for assembling the unit, comprising:
repeating for each assembly event on the assembly flow:
extracting script commands for the assembly event comprising:
repeating for each relevant part or part combination associated with the assembly event, the relevant part retrieved from the map of the unit:
adapting the script commands in accordance with the assembly event and
accumulating the script commands as adapted to existing script commands generated on previous iterations of the assembly event and previous assembly events; and
storing the script commands as accumulated.
